(19) United States
(12) Patent Application Publication
(10) Pub. No.: US 2003/0154857 A1
(43) Pub. Date: Aug. 21, 2003

(54) Separation of metabolic carbon dioxide (CO2) from the atmosphere of a closed habitable environment

(76) Inventor: Karen Murdoch, Broad Brook, CT (US)

Correspondence Address: William W. Jones, 6 Juniper Lane, Madison, CT, 06443, US

(21) Appl. No.: 10/078,296

(22) Filed: Feb. 20, 2002

(51) Int. Cl. B01D 53/22

(52) U.S. Cl. 95/51; 96/4; 55/385.2

(57) ABSTRACT

A high capacity carbon dioxide (CO₂) separation membrane is operative to separate CO₂ from oxygen in a closed habitable environment, such as a space suit or a space station. The membrane is a porous hydrophilic material which is impregnated with a solution of a low vapor pressure hygroscopic solvent containing an alkali metal carbonate solute. The solution is relatively impermeable to oxygen whereby minimal amounts of oxygen will pass through the membrane. The driving force used to cause the carbon dioxide to diffuse through the membrane can be the low pressure or vacuum of space on the exit side of the membrane, or can be the result of a positive pressure sweep gas stream flowing by the membrane over a side thereof opposite to the habitable environment. The partial pressure of carbon dioxide on the entry side of the membrane is significantly higher that the partial pressure of carbon dioxide on the exit side of the membrane. The alkali metal carbonate in the solution converts to the bicarbonate form due to the presence of carbon dioxide and water vapor on the higher CO₂ partial pressure entry side of the membrane, and then converts back to the carbonate form upon releasing carbon dioxide on the lower CO₂ partial pressure exit side of the membrane.

The invention described herein was made in the performance of work under NASA Contract No. NAS9-18587 and is subject to the provisions of Section 305 of the National Aeronautics and Space Act of 1958 (42 U.S.C. 2457).

### TECHNICAL FIELD.

The present invention relates to an improved membrane-based method and system for separating metabolic carbon dioxide (CO₂) from the atmosphere in a habitable environment. More particularly, this invention relates to a CO₂ separation membrane, a solution, and a system which performs well in a space application environment. Still further, this invention relates to a method for making the CO₂ separation membrane.

### BACKGROUND OF THE INVENTION

Exposure to carbon dioxide partial pressures which exceed about 7.6 mm Hg (millimeters of mercury, partial pressure of about 1%), for extended periods of time are known to cause health problems in human beings and in other mammals. As a result, in enclosed environs such as those existing in submarines, space stations, space crafts, or space suits, carbon dioxide partial pressures are typically maintained below about 1% through the use of solid carbon dioxide sorbents such as soda lime, zeolite and carbon molecular sieves, solid oxides, alkali metal carbonates, alkali metal hydroxides, amines, and combinations of the aforesaid sorbents.

Membrane separation of carbon dioxide from a breathable atmosphere has been suggested for use as a possible next evolution of life support systems in closed environments of the types described above. The membrane CO₂ separation approach can utilize the vacuum of space to provide the required driving force to drive the carbon dioxide through the membrane in appropriate applications. The literature presently suggests that the permeation rate of carbon dioxide through presently proposed membranes is on the order of 5×10⁻⁴ cm³/cm²·s·Hg, and the separation factor, or selectivity, of CO₂ /N₂ is on the order of 10 to 20. The use of such a membrane in a space suit application, for example, would require over 6 m² of membrane area. The carbon dioxide in the breathing loop must be maintained below 1% to avoid the toxic effects of CO₂. A membrane system with a separation factor of only 20 which is suggested by the literature presently available, used at a pressure ratio of 99:1 oxygen to CO₂ results in the loss of 0.67 lb/hr oxygen in order to remove the required amount of metabolically generated CO₂ which is 0.19 lb/hr. The O₂ lost due to membrane permeation is about four times that which is consumed for respiration. The CO₂ separation factor of such membranes is thus impractical for use in space applications since the separation membrane is too permeable to oxygen.

### DISCLOSURE OF THE INVENTION

This invention relates to a carbon dioxide separation membrane, a system which incorporates such a membrane, and a method for using such a membrane which provides increased CO₂ separation from O₂ as compared to separation membrane systems suggested in the present literature. The membrane of this invention has a CO₂ permeation rate of 8.5×10⁻⁴ cm³/cm²·s·Hg (wherein “cm³” is the volume of the gas transferred; “cm²” is the area of the membrane surface; “s” is time in seconds; and “cmHg” is pressure in mercury column centimeters). This would require only 4 m² (square meters) of membrane area for a space suit application. This membrane also has a separation factor CO₂ /O₂ of 895. A minimum separation factor of 333, which equates to 3% of the metabolic O₂ being lost from the habitable environment, should be achieved in order for the system to have sufficient utility. The phrase “separation factor” or term “selectivity” refers to the relative rate of transfer of CO₂ versus O₂ through the separation membrane. The lower required area and higher separation factor combine to incur an oxygen loss of only 0.014 lb/hr.

This invention involves the use of a micro porous hydrophilic membrane which is impregnated with a solution comprising a low vapor pressure hygroscopic solvent and an alkali metal carbonate solute. The impregnated membrane of this invention is used in an application wherein the partial pressure of carbon dioxide on a habitable environment side of the membrane is significantly higher than the partial pressure of carbon dioxide on an opposite uninhabitable ambient side of the membrane, the partial pressure differential providing a driving force for the carbon dioxide transport through the impregnated membrane. The membrane material is poly sulfone such as SUPOR™ (trademark) made by Gelman Sciences or polyvinylidene (PVDF) such as a PALL™ (trademark) membrane made by Pall Corp. The hydrophilic nature of the membrane wicks the solution into the membrane pores, and maintains the solution therein in a liquid state by means of surface tension.

The hygroscopic solvent is such that is has solubility for the alkali metal carbonate and water, and it also has a low vapor pressure. Glycerol, diethanolamine and polyethylene glycol are among a group of materials which have these characteristics. The solubility for the alkali metal carbonate allows diffusion of the solute within the solvent so that it can transport the carbon dioxide from the high pressure side to the low pressure side easily. The solvent also has a low solubility of oxygen so that oxygen passage through the membrane is kept to a minimum.

The alkali metal carbonate solute provides the transport mechanism for the CO₂ through the impregnated membrane. The carbonate solute converts to the bicarbonate form in the presence of CO₂ and water vapor on the high CO₂ partial pressure side of the membrane. The bicarbonate then converts back to the carbonate on the low CO₂ partial pressure side of the membrane. Sodium carbonate and cesium carbonate both are soluble in glycerol and have been shown to have utility in this application.

The membrane is prepared as follows. The solution is prepared by dissolving the carbonate in the solvent. The solution should be maintained in situ for a time sufficient to completely dissolve all of the carbonate in the solvent. The salt can be confirmed as being completely dissolved in the solvent when a precipitate is no longer visible in the solvent. If excess salt is in the solvent, it will form a salt dispersion in the solvent and the solution will operate, however, somewhat less, efficiently. Thus, there should be sufficient salt in the solvent so as to at least completely saturate the solvent with dissolved salt. Once salt-solvent saturation is achieved, the hydrophilic membrane is then placed on top of the solution so that only one side of the membrane touches the solution. The membrane then will wick up the solution into the membrane pores. The membrane can then be suspended vertically so as to drain off excess solution. A scraping tool such as a spatula, a doctor blade, or the like, can be used to remove excess solution from the membrane.

The difference in the partial pressure of CO₂ on opposite sides of the membrane is what enables the conversion of CO₂ to a bicarbonate in the solution contained in the pores in the membrane and the reconversion back to CO₂ at the exit surface of the membrane. Likewise, the difference in atmospheric pressures on opposite sides of the membrane is what draws the O₂/CO₂ mixture to the membrane. The partial pressure of CO₂ on the entry side of the membrane is greater than the partial pressure of CO₂ on the exit side of the membrane; and the atmospheric pressure on the entry side of the membrane is greater than the atmospheric pressure on the exit side of the membrane.

It is therefore an object of this invention to provide a CO₂ separation system and method which is operable to strip CO₂ from a breathable atmosphere disposed in a closed habitable environment such as a space craft, space suit, submarine, space station, or the like.

It is an additional object of this invention to provide a system and method of the character described which utilizes a separation membrane which will diffuse CO₂ out of the atmosphere in question and transport the diffused CO₂ to an ambient surrounding in which the habitable environment is situated.

It is a further object of this invention to provide a system and method of the character described wherein the habitable environment is disposed in ambient surroundings wherein the carbon dioxide partial pressure in the habitable environment is greater than the carbon dioxide partial pressure in the ambient surroundings.

It is another object of this invention to provide a system and method of the character described wherein the separation membrane is porous and is impregnated with a solution which converts CO₂ to another compound which can migrate through the solution from the habitat side of the membrane to the ambient side of the membrane, whereupon the other compound is converted back to its original form when CO₂ is released to the ambient surroundings.

These and other objects of the invention will become more readily apparent from the following detailed description thereof when taken in conjunction with the accompanying drawing in which:

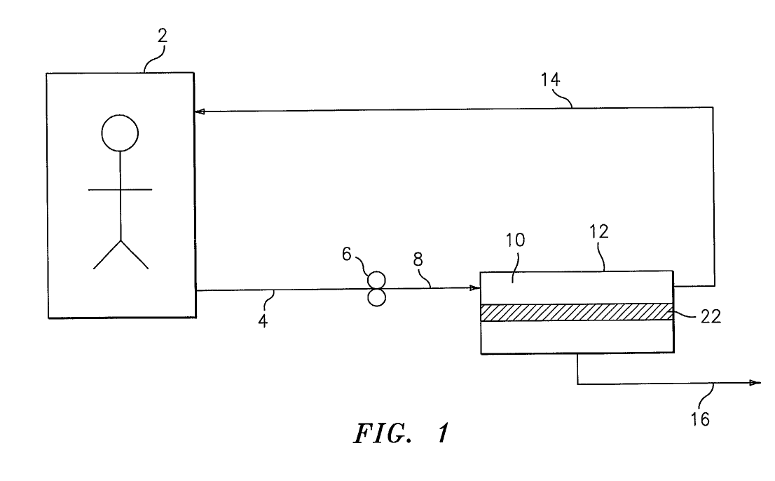

FIG. 1 is a schematic view of a habitable environment which incorporates the CO₂ removal system of this invention; and

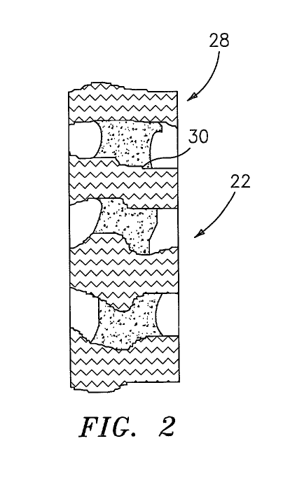

FIG. 2 is a fragmented cross-sectional view of the separation membrane formed in accordance with this invention.

### SPECIFIC MODE FOR CARRYING OUT THE INVENTION

Referring now to the drawings, FIG. 1 is a schematic view of a habitable environment, such as a space suit, which is denoted generally by the numeral 2, and an adjunct system 3 for removing carbon dioxide (CO₂) from the environment 2. The environment contains oxygen (O₂) for breathing, and, of course, CO₂, which is a metabolic by-product of breathing. The O₂/CO₂ mixture is drawn from the environment 2 through a line 4 by a fan 6 into a line 8 which communicates with a CO₂ membrane module 12. The line 8 opens into an inlet side 10 of the module 12 so as to expose the O₂/CO₂ mixture to the membrane 22, details of which will be further explained below. The CO₂ component of the mixture dissolves into the liquid component of the membrane 22 and reacts therein with the metal carbonate forming bicarbonate, CO₂ concentration differences on opposite sides of the membrane 22 cause the bicarbonate to migrate through the membrane 22 to the ambient side 18 of the module 12 where the bicarbonate dissociates to CO₂ and metal carbonate. The CO₂ exits the membrane module 12 through a line 16 which opens into the ambient surroundings of the environment 2. Oxygen that enters the membrane module 12 does not easily diffuse through the membrane 22, and therefore most of the O₂ is recycled to the environment 2 through a line 14. The recycled O₂ is essentially devoid of CO₂.

Referring now to FIG. 2, there is shown a fragmented cross-sectional view of the CO₂ separation membrane 22. The membrane 22 includes a porous polymer component 28 having pores 30. The porous polymer component can take the form of hollow fibers or flat sheets, either form being acceptable. The membrane 22 is hydrophilic so as to be capable of wicking an aqueous based solution 32 into the membrane pores 30 wherein the solution 32 is maintained in its liquid form by surface tension. As noted above, the solution 32 includes an alkali metal carbonate solute which is dissolved in the hygroscopic solvent.

It will be readily appreciated by those skilled in the art that this invention can provide a CO₂ removal membrane possessing a high CO₂ permeation rate which enables a smaller membrane area. Thus less system volume and weight are needed to remove any given amount of CO₂ from the atmosphere of the closed habitable environment in question. The membrane of this invention also possesses a low O₂ permeation rate along with a high CO₂/O₂ separation factor, which ensures minimal loss of O₂ from the habitable environment through the CO₂ removal membrane. This is an important advantage since O₂ is a consumable that must be resupplied to the habitable environment if it is lost during the CO₂ removal process. The inclusion of a low vapor pressure solvent provides a longer useful life for the membrane, which solvent does not evaporate from the membrane or leak out of the membrane, as would water.

Since many changes and variations of the disclosed embodiment of the invention may be made without departing from the inventive concept, it is not intended to limit the invention otherwise than as required by the appended claims.

What is claimed is:

1. A membrane assembly for removing metabolic carbon dioxide (CO₂) from a habitable environment, said membrane assembly comprising a porous hydrophilic membrane, pores of which contain a low vapor pressure hygroscopic solvent having an alkali metal carbonate compound dissolved therein.

2. The membrane assembly of claim 1 wherein said membrane has a CO₂ permeation rate of 8.5×10⁻⁴ cm³/cm²·s·Hg, wherein cm₃is the volume of the gas transferred through the membrane; cm²is the area of the membrane surface; s is time in seconds; and cmHg is pressure in mercury column centimeters.

3. The membrane assembly of claim 1 wherein the relative rate of transfer of CO₂ versus O₂ through the membrane assembly, which is also known as the “separation factor” is at least 333.

4. The membrane assembly of claim 3 wherein the separation factor is about 895.

5. The membrane assembly of claim 3 wherein the amount of O₂ transferred through the membrane assembly is about 0.014 lb/hr.

6. The membrane assembly of claim 1 wherein the membrane is formed from a polymer which is selected from the group consisting of a polysulfone and a polyvinylidene.

7. The membrane assembly of claim 1 wherein said solvent is a hygroscopic solvent which is selected from the group consisting of glycerol, diethanolamine and polyethylene glycol.

8. The membrane assembly of claim 1 wherein said alkali metal carbonate compound is a compound which is selected from the group consisting of sodium carbonate, cesium carbonate, potassium carbonate and calcium carbonate.

9. A method for removing metabolic carbon dioxide (CO₂) from an air stream derived from a closed habitable environment so as to produce a lower CO₂ concentration in said air stream, said method comprising:
a) the step of providing a porous hydrophilic membrane, pores of which contain a solution of a low vapor pressure hygroscopic solvent having an alkali metal carbonate compound dissolved therein; and
b) the step of passing the air stream over an entry side of the membrane so as to convert CO₂ in the air stream to a bicarbonate in said solution in the membrane thereby reducing the amount of CO₂ in the air stream.

10. The method of claim 9 further comprising the further step of returning the air stream to the habitable environment.

11. The method of claim 9 wherein partial pressure of CO₂ on the entry side of the membrane is greater than partial pressure of CO₂ in an ambient environment on an exit side of the membrane, in which said ambient environment the habitable environment is located.

12. The method of claim 11 wherein atmospheric pressure on the entry side of the membrane is greater than atmospheric pressure in the ambient environment on the exit side of the membrane so as to draw the air stream to entry side of the membrane.

13. The method of claim 11 wherein the bicarbonate is converted back to CO₂ in the ambient environment.

14. The method of claim 9 wherein passage of oxygen (O₂) through said membrane is restricted.

15. A method for removing metabolic carbon dioxide (CO₂) from an air stream which contains oxygen (O₂) and metabolic CO₂, which air stream is derived from a closed habitable environment, said method comprising:
a) the step of providing a porous hydrophilic membrane, pores of which contain a solution of a low vapor pressure hygroscopic solvent having an alkali metal carbonate compound dissolved therein, said solution being permeable by CO₂ and being substantially impermeable by O₂; and
b) the step of drawing the air stream toward an entry side of the membrane so as to selectively draw CO₂ into said solution while restricting O₂ entry into said solution thereby reducing the amount of CO₂ in the air stream.

16. A system for removing metabolic carbon dioxide (CO₂) from an air stream which is derived from a closed habitable environment, said system comprising:
a) a first line for drawing the air stream from the habitable environment;
b) said line communicating with an entry side of a porous hydrophilic membrane, pores of which membrane contain a solution comprising a low vapor pressure hygroscopic solvent and an alkali metal carbonate compound dissolved therein, said solution being operable to convert CO₂ in said air stream to a bicarbonate compound in said solution; and
c) a second line for removing reconverted CO₂ from an exit side of said membrane.

17. A solution for removing metabolic carbon dioxide (CO₂) from an air stream which air stream is derived from a closed habitable environment, said solution comprising a low vapor pressure hygroscopic solvent having an alkali metal carbonate compound dissolved therein.

18. A method for preparing a membrane assembly which is useful for removing metabolic carbon dioxide (CO₂) from an air stream which is derived from a habitable environment, said method comprising:
a) the step of providing a porous hydrophilic membrane;
b) the step of preparing a solution of an alkali metal carbonate solute which is dissolved in a low vapor pressure hygroscopic solvent;
c) the step of contacting the membrane with the solution in a manner wherein the membrane will wick up the solution into the membrane's pores; and
d) the step of removing excess solution from the membrane.
